(19) United States
(12) Patent Application Publication
(10) Pub. No.: US 2003/0056869 A1
(43) Pub. Date: Mar. 27, 2003

(54) Label inventory control system

(75) Inventors: Daniel A. Tate, Oak Glen, CA (US); Robert R. Goetz, Garden Grove, CA (US); Kent Tabor, Mequon, WI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: FMC Technologies, Inc., Chicago, IL (US)

(21) Appl. No.: 09/964,969

(22) Filed: Sep. 27, 2001

(51) Int. Cl. B32B 31/00

(52) U.S. Cl. 156/64; 156/350; 156/558

(57) ABSTRACT

A method and system for maintaining the inventory of labels is presented. An inventory count for each label type is maintained in a database. The database is updated when the labeler is operated by detecting the label type being used by a labeler by counting and subtracting the number of labels dispensed from the inventory count. The inventory count is adjusted from a remote location or via an operator interface. The system may be integrated with a labeler controller. The system includes a label sensor and counter for detecting and counting labels, a label database, a processing unit, an operator interface, and a gateway connection. An alarm is provided when the inventory of a label type is low and labels of the label type are automatically reordered if a reorder option is selected.

### FIELD OF THE INVENTION

The present invention relates generally to labelers, and more particularly relates to a label inventory control system for labelers.

### BACKGROUND OF THE INVENTION

One industry in which automatic labelers are used to apply labels to articles is packing houses for perishable produce items such as fruit and vegetables. In produce packing houses, the speed at which labels are applied to the produce can be very important because the perishable produce must be packed and shipped quickly in order to maximize the shelf life of the produce in stores. Moreover, packing houses typically handle several different varieties of produce each of which is assigned a different type of label. As a result, packing houses typically use a number of high speed labelers each of which is capable of applying a variety of different labels. These produce labeling operations require an efficient and effective system to monitor and maintain the supply of the different types of labels to assure that the perishable items are labeled in a timely manner.

### BRIEF SUMMARY OF THE INVENTION

The present invention provides a method and system for maintaining the inventory of labels. An inventory count for each label type is maintained in a database. The inventory count is updated when the labeler is operated by detecting the label type being used by a labeler and counting the number of labels dispensed. The inventory count is adjusted from a remote location or via an operator interface.

The operator interface provides a user with the ability to view current label inventory and to enter a percentage hit rate value for the labeler. The system may be integrated with the labeler controller. The system includes a label sensor for detecting labels, a label database, a processing unit, an operator interface, and a gateway connection. An alarm or other action is generated when the inventory of a label type is low and the label type is automatically reordered if a reorder option is selected.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an end view of an exemplary label system in which the present invention operates;

FIG. 2 is a block diagram generally illustrating an exemplary computer system on which the present invention resides;

FIG. 3 is a block diagram illustrating an embodiment of a label inventory system in accordance with the teaching of the present invention; and

FIGS. 4a and 4b illustrate a flow chart of a method of maintaining label inventory in accordance with the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

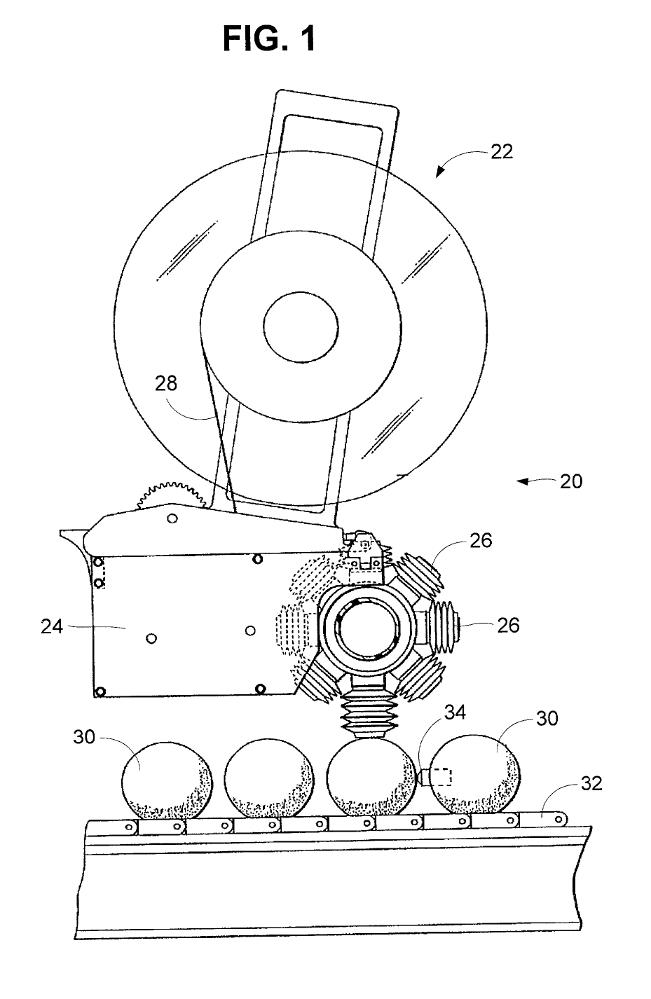

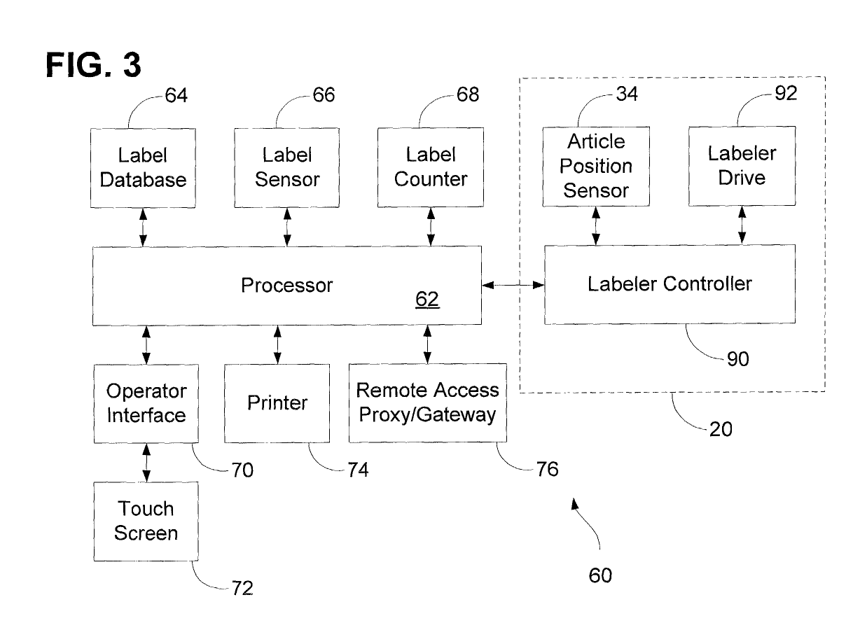

The present invention provides an inventory control system for labelers. Turning to the drawings, wherein like reference numerals refer to like elements, an exemplary labeler 20 with which the present invention can be used is illustrated in FIG. 1. The illustrated labeler 20 is a vacuum or bellows type labeler. The labeler 20 includes a label cassette 22 engaged with the labeler housing 24. The label cassette 22 supplies a label carrier strip 28 which is led through the cassette to a separation plate which separates the labels from the carrier strip. A rotary bellows wheel is arranged underneath the separation plate and operates to apply the separated labels to articles 30, in the illustrated embodiment fruit or vegetables, that are carried past the labeler on a conveyor 32. In particular, the bellows wheel includes a number of bellows 26 that respectively pick up each separated label by means of a vacuum applied through the respective bellows 26. The bellows 26 then transports the label to an article 30 and applies the labels to the article through expansion of the bellows. An article sensor 34 detects when an article 30 approaches the label application position and signal the labeler controller 90 (see FIG. 3) which, in turn, directs the bellows 26 to extend and contact the article. Further details of the bellows type labeler are in U.S. Pat. Nos. 5,829,351, 6,047,755, and 6,230,779, which are hereby incorporated by reference in their entirety.

While the present invention will be described in connection with the illustrated zing labeler 20, those of ordinary skill in the art will recognize that the present invention works on any type of small article labeler. For example, the present invention can be used with compressed air labelers, tamper labelers, and laid-on type labelers. Compressed air labelers trigger a burst of compressed air at a label when an article approaches which blows the label onto the article. A tamper labeler utilizes a piston-type applicator which tamps labels onto the articles. As compared to bellows, compressed air and tamper labelers, laid-on type labelers have a much simpler construction which does not utilize a separate label applicator mechanism to transport and apply the labels to the articles. Instead, this type of labeler utilizes an elongated applicator arm having a peel blade at its free end. The peel blade separates the labels from a carrier strip so as to position the labels for direct application to the articles. The separated labels are then pressed onto the articles by a roller that is also arranged at the free end of the applicator arm.

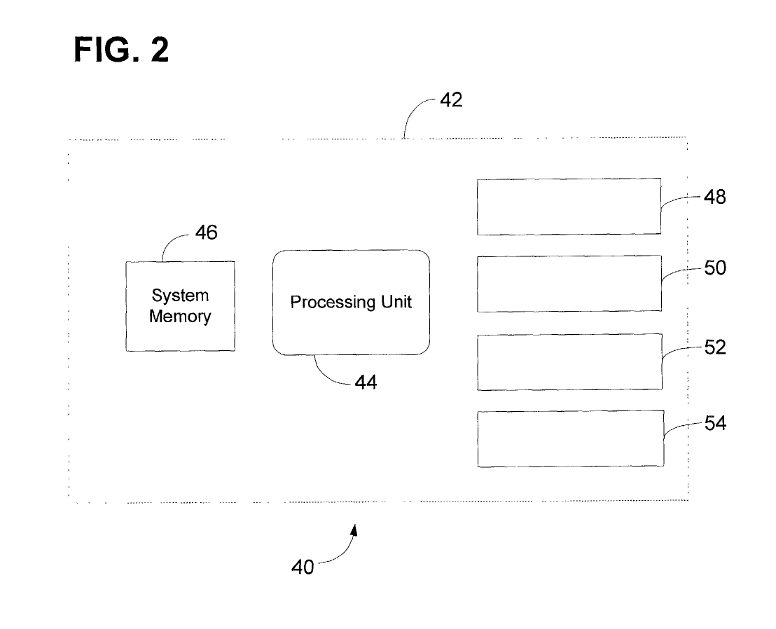

An example of a suitable computing system environment 40 on which the invention may be implemented is illustrated in FIG. 2. Of course, the computing system environment 40 is only one example of a suitable computing environment and is not intended to suggest any limitation as to the scope of use or functionality of the invention. The invention is operational with numerous other general purpose or special purpose computing system environments or configurations. Examples of well known computing systems, environments, and/or configurations that may be suitable for use with the invention include, but are not limited to, personal computers, hand-held or laptop devices, programmable logic controllers, microprocessor-based systems, programmable consumer electronics, network PCs, minicomputers, mainframe computers, distributed computing environments that include any of the above systems or devices, and the like.

Although not required, the invention is described hereinafter in the general context of computer-executable instructions, such as program modules, being executed by a processing unit in a computer. Generally, program modules include routines, programs, objects, components, data structures, and the like that perform particular tasks or implement particular abstract data types. Moreover, those skilled in the art will appreciate that the processing unit may be implemented in other computer system configurations, including programmable logic controllers (PLCs), hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 2, an exemplary system for implementing the invention includes a general purpose computing device in the form of a computer 42. In its most basic configuration, computer 42 typically includes a processing unit 44 and system memory 46. Depending on the exact configuration and type of computing device, memory 46 may be volatile (such as RAM), non-volatile (such as ROM, flash memory, etc.) or some combination of the two. The computer 42 may also have removable mass storage and/or non-removable mass storage 48 such as magnetic disks, magnetic cassettes, optical disks or tape. Similarly, computer 42 may also have input devices 50 such as a mouse, a keyboard, a modem, and the like and/or output devices 52 such as a display, a printer, speakers and the like. Other aspects of computer 42 may include network connections 54 to other devices, computers, networks, servers, etc. using either wired or wireless media or a combination of the above. All of these devices are well known in the art and need not be discussed at length here.

Computer 42 typically includes at least some form of computer readable media. By way of example, and not limitation, computer readable media may comprise computer storage media and communication media. Computer storage media includes volatile and non-volatile, removable and non-removable media (such as removable mass storage and/or non-removable mass storage 48) implemented in any method or technology for storage of information such as computer readable instructions, data structures, program modules or other data. Computer storage media includes, but is not limited to, RAM, ROM, EEPROM, flash memory, or other memory technology, CD-ROM, digital versatile disks (DVD) or other optical storage, magnetic cassettes, magnetic tape, magnetic disk storage or other magnetic storage devices, or any other medium which can be used to store the desired information. Communication media typically embodies computer readable instructions, data structures, program modules, or other data in a modulated data signal such as a carrier wave or other transport mechanism and includes any information delivery media.

Turning now to FIG. 3, a block diagram of an exemplary embodiment of an inventory control system 60 according to the present invention is shown. As will be appreciated from the following description, the label inventory control system 60 can be used to efficiently monitor, maintain and otherwise control the supply of labels to one or more labelers on either a semi- or fully-automated basis. For example, depending on how the invention is implemented, the label inventory control system 60 could be used to input and report on label inventory information and automatically track use of, print reports and reorder labels with little or no operator input. This system has particular application in packing houses for perishable produce items such as fruits and vegetables where labeling the items in a timely manner is a critical concern. Of course, the invention could be used in other contexts and is not limited to providing any particular inventory control features. The label inventory control system 60 is implemented in an environment that is equivalent or similar to the computing system environment 40. In the illustrated embodiment, the label inventory control system 60 has a processing unit 62 that performs computations that are required, executes program modules of the label inventory control system 60 and communicates with other elements of the label inventory control system and the controller of the labeler.

The present invention works with several types of labels. For example, the different types of labels may be distinguished by barcodes, hole patterns in the label, images on the label, the shape of the label, etc. Thus, the different types of labels have some sort of visually discernable difference from other labels which defines the particular label type. For example, in one embodiment, the label type is defined by the PLU (Price look Up) number that is on the label. The label types can also be defined by a UPC (Universal Product Code) number, an article type (e.g., apple label, orange label, etc.), a trademark (e.g., Dole® banana) and the like. To contain and store an inventory count of each label type used, a label database 64 is in communication with processing unit 62. The inventory count is the number of labels present at a defined location. The location is user defined and typically is defined to be the labels that are at a particular packing house. Alternatively, the inventory count may be for both a particular location and for the total number of labels of each label type that are available for use (e.g., the number of labels at a site and at a central warehouse). The label database 64 is also used for tracking usage by label type, for determining historical patterns of label usage, and for obtaining trending information.

A label sensor 66 in communication with processing unit 62 determines the label type. To this end, the label sensor 66 is mounted proximate to the labeler 20 in a location that enables it to determine the label type. The label sensor 66 can be a camera, an optical sensor, a bar code reader and the like. In one embodiment, a label counter 68 in communication with label sensor 66 and processing unit 62 counts the number of labels dispensed by the labeler 20. While shown as a separate block, label counter 68 may be integrated with label sensor 66 or processing unit 62. In another embodiment, the inventory count is updated after each label is dispensed, eliminating the need for the label counter 68. Although not required, the invention is described hereinafter using the label counter 68.

For interfacing with an operator, an operator interface 70 is provided. In one embodiment, the operator interface 70 has a touch screen 72 that provides the user (i.e., operator, service person, management, and the like) with a means to receive inventory information and provide input to the label inventory control system 60. For example, the user can view current inventory (i.e., the inventory count) of each label type via the touch screen 72. Additionally, the current inventory can be adjusted by the user for various reasons, including label restocking, borrowed labels, damaged labels, correcting a prior incorrect input, and the like. The system can be configured such that the adjustment is only executed when the user enters a password. Alternatively, a keyboard and monitor can be used to receive and input information. In a further embodiment, the operator interface comprises an infrared port such that a personal digital assistant (PDA) and the like can be used to interface with the label inventory control system 60.

To provide further inventory information, the processing unit can be adapted to generate label inventory reports for all or a select number of label types based on a frequency selected by the user. The frequency may be daily, weekly, monthly, quarterly, etc. Additionally, a current inventory report and a label historical usage report can also be generated at the request of the user. The label historical usage report can be used to order labels based on past usage. The reports are printed at printer 74 or sent to a remote location via remote access proxy/gateway 76.

The remote access proxy/gateway 76 provides a remote location with access to the label inventory control system 60. The remote location accesses the gateway 76 by a dial-up modem, a LAN, a WAN, a wireless network, or a satellite. The label inventory control system 60 provides the remote location with the same options available to the local user at the operator interface. These options include the capability to view current inventory information, to receive reports, and to adjust label inventory.

The processing unit 62 is in communication with the labeler controller 90 to provide input to the labeler controller 90 and receive status from the label controller 90. Those of ordinary skill in the art will recognize that the processing unit 60 may be integrated into the labeler controller 90. The primary function of labeler controller 90 is to receive the article position from article position sensor 34 and command the labeler via labeler drive 92 to place a label on the article detected by the article position sensor 34.

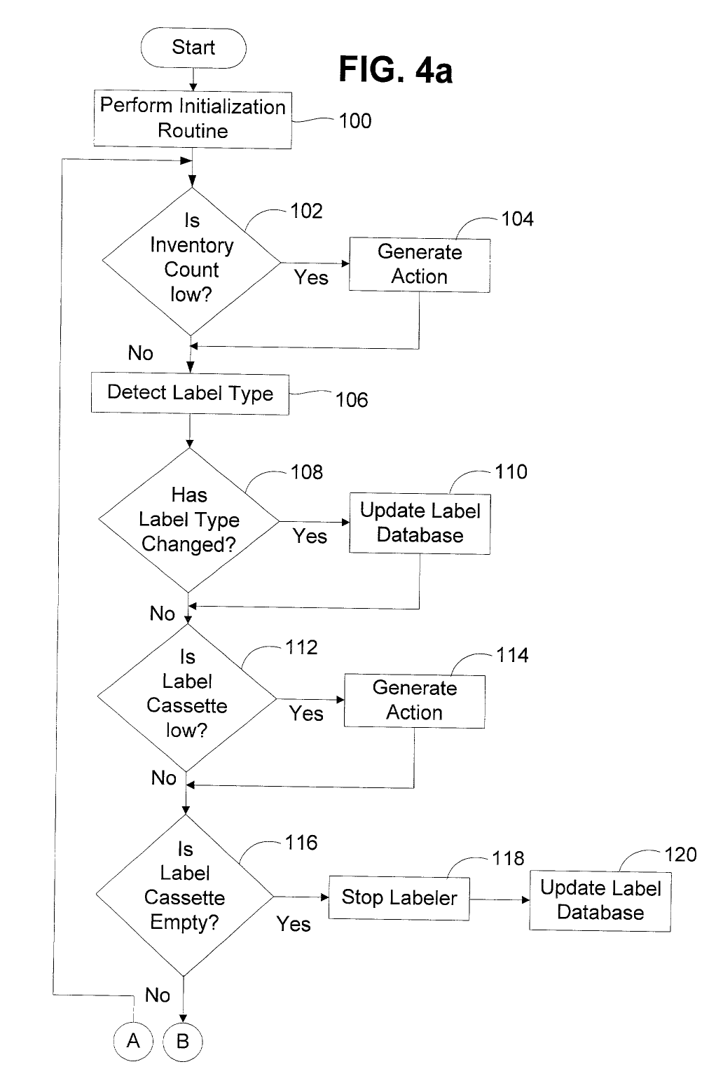

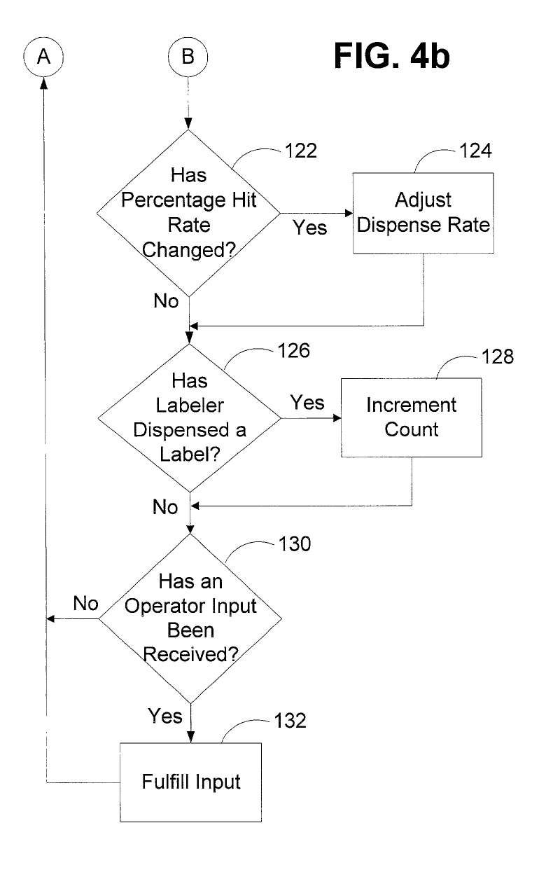

Now that the architecture in which the invention operates and resides has been described, the steps taken to maintain label inventory are illustrated in FIGS. 4a and 4b. The steps may be performed periodically or continually. Turning now to the flow diagram of FIGS. 4a and 4b, the processing unit 62 performs an initialization routine when it is energized (step 100). Generally, the initialization routine performs checks to verify proper operation of the label inventory control system 60. In one embodiment, the initialization routine resets counters and runs a built-in-test (BIT) routine to verify that component settings are correct.

In this case, one step performed by the system is a check of the current inventory of labels for each label type (step 102). If any inventory count for a particular label type is below a threshold set by a user having authorization, an action such as an alarm is generated (step 104). The action can be a message, an illuminated light, an audio alarm, and the like. A different threshold can be set for each label type via the operator interface 70 or remotely via the gateway 76. In one embodiment, the action is a message that appears on the touch screen 72. The message is also sent to the label supplier and personnel responsible for ordering labels via the gateway 76 indicating that there is a pending shortage for the particular label type. An alarm message is placed on the label inventory report until the inventory for the label type is increased above the threshold. In another embodiment, the processing unit 62 sends a flag to a labeling service via the gateway 76 and the labeling service automatically orders labels to update the inventory.

The label inventory control system 60 can maintain an inventory for any number of labelers. It can be networked with a plurality of labelers or set up on individual labelers. When a labeler being monitored by the label inventory control system 60 is operating, the label type is detected by the label sensor 66 (step 106). If the label type has changed (step 108) the processing unit 60 updates the inventory count for the label type previously used in the label database 64 by subtracting the number of labels dispensed from the inventory count (step 110). The label counter 68 is reset when the label database is updated.

The processing unit 62 also detects when the label cassette is low (step 112). Specifically, an action is generated when the number of labels in the label cassette falls below a threshold level (step 114). The action may be a message appearing on the touch screen or sent to a remote location, a warning light, or an audible alarm. In one embodiment, a marker is placed in the label cassette. The marker can be a color strip recognizable by the label sensor 66 that is placed by the label manufacturer at a point on the web 28 such that the number of remaining labels is equal to or below the threshold level. When label sensor 66 detects the marker, the processing unit 62 generates the action. In an alternate embodiment, an optical sensor (e.g., a photo emitter and photo detector) is used. The photo emitter sends a pulse signal aimed at the labels in the label cassette and times the return of the pulse (i.e. when the photo detector detects the pulse). As the number of labels in the label cassette 22 decreases, the return time increases. When the return time is equal to or greater than a predetermined time, which indicates the label cassette is low, the action is generated.

When the processing unit 62 detects that the label cassette is empty (step 118), the processing unit 62 commands the labeler controller 90 to stop the labeler 20. Alternatively, the labeler controller detects that the label cassette is empty, stops the labeler, and sends a message to the processing unit 62. The processing unit 62 updates the inventory count in the label database for the label type being used and resets the counter (step 120). If more than one labeler is being monitored by the label inventory control system 60, the steps continue. If only one labeler is being monitored, the processing unit 62 stops monitoring and waits for further input from the operator.

There may be circumstances where the operator does not want to have every article labeled. For example, if the labels being used indicate the type of article (e.g., a Jonathan apple), then it may not be necessary to label every article. In these types of situations, the present invention provides the user with the capability to specify the percentage of articles that should be labeled. This percentage is called a percentage hit rate. The operator changes the percentage hit rate via the operator interface 70 or via a remote location using the gateway 76. When the processing unit 62 detects that the percentage hit rate has been changed (step 122) it sends a message to the labeler controller 90 to adjust the dispense rate so that the labeler 20 dispenses labels in accordance with the percentage hit rate (step 124). For example, if the percentage hit rate is twenty, the labeler 20 labels twenty percent of the articles being labeled.

Each time the label sensor detects that a label has been dispensed (step 126) the inventory count is adjusted (step 128). The count may be displayed on the touch screen 72 and be sent to a remote location via the gateway 76.

As previously described, the operator can provide input to the label inventory control system 60 via the operator interface 70 or the gateway 76. When an operator input has been detected (step 130), the processing unit 62 performs any steps that may be needed to fulfill the input (step 132). For example, if the operator inputs an inventory adjustment for a particular label type, the processing unit 62 updates the inventory count in the label database 64 for the particular label type. Other inputs include viewing the current inventory of all labels or particular labels, printing or sending inventory reports, setting thresholds, updating program modules, and adding program modules. The method outlined in steps 102 to 132 are repeated until the label inventory control system 62 is stopped.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. For example, the inventory count may be updated after a select number of labels are dispensed or after a predetermined period of time has elapsed. Those of ordinary skill in the art will recognize that the elements of the illustrated embodiment shown in software may be implemented in hardware and vice versa or that the illustrated embodiment can be modified in arrangement and detail without departing from the spirit of the invention. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A label monitoring system for use with a labeler comprising:
a label sensor to detect at least one label type being dispensed by the labeler, the label sensor operatively connected to the labeler;
a label database having an inventory count of the at least one label type;
a processing unit in communication with the label sensor and the label database, the processing unit updating the inventory count of the at least one label type being dispensed in response to the label sensor detecting the at least one label type; and
an operator interface operatively connected to the processing unit.

2. The label monitoring system of claim 1 including a label counter in communication with the label sensor to count a number of labels being used by the labeler for the at least one label type.

3. The label monitoring system of claim 1 further comprising a controller in communication with the operator interface, the controller including:
a position sensor for detecting a position of an article; and
a label driver for commanding the labeler to dispense a label in response to the article being at a predetermined position.

4. The label monitoring system of claim 3 wherein the operator interface includes a percentage hit rate input and wherein the controller further comprises a controller processing unit for adjusting the label driver to command the labeler to dispense a label in response to the article being at a predetermined position and in accordance with the percentage hit rate input.

5. The label monitoring system of claim 1 wherein the operator interface includes a touch screen for receiving input from an user and providing output to the user.

6. The label monitoring system of claim 4 wherein the processing unit updates the label database in response to an inventory adjustment input received from the user.

7. The label monitoring system of claim 1 further comprising an alarm to provide an alarm message when a reorder is needed for the at least one label type.

8. The label monitoring system of claim 1 further comprising a gateway connection for communication with at least one remote location.

9. The label monitoring system of claim 8 wherein the processing unit updates the inventory count when an adjustment number is received from one of the operator interface and the remote location.

10. The label monitoring system of claim 1 wherein the at least one label type comprises a plurality of label types.

11. A computer-readable medium having computer executable instructions for performing steps to maintain an inventory control of labels used in a labeler, the computer-executable instructions performing the steps of:
detecting at least one label type being used by the labeler;
updating an inventory count of the at least one label type by subtracting the number of labels of the at least one label type dispensed from the inventory count of the at least one label type;
adjusting the inventory count of the at least one label type in response to receiving an inventory adjustment number; and
generating an action if the inventory count of the at least one label type falls below a predetermined level.

12. The computer-readable medium of claim 1 1 having further computer-executable instructions for performing the step of providing a status of inventory in response to a request from one of a remote location and an operator interface.

13. The computer-readable medium of claim 12 wherein the step of providing a status of inventory includes the step of generating an inventory report at at least one of the remote location and the operator interface.

14. The computer-readable medium of claim 11 wherein the inventory adjustment number is supplied by a user and wherein the step of adjusting the inventory count of the at least one label type in response to receiving an inventory adjustment number includes verifying that the user is authorized to adjust the inventory count.

15. The computer-readable medium of claim 11 having further computer-executable instructions for performing the steps of:
detecting if a number of labels in a label cassette is below a threshold number; and
generating a second action if the number of labels in the label cassette is below the threshold number.

16. The computer-readable medium of claim 11 having further computer executable instructions for performing the step of changing the predetermined level from a first value to a second value in response to receiving a command to change the predetermined level from a user.

17. The computer-readable medium of claim 11 having further computer executable instructions for performing the step of counting a number of labels of the at least one label type dispensed by the labeler.

18. The computer-readable medium of claim 11 wherein the at least one label type comprises a plurality of label types.

19. A method for maintaining an inventory control of labels used in a labeler comprising the steps of:
detecting at least one label type being used by the labeler;
counting a number of labels of the at least one label type dispensed by the labeler;
updating an inventory count of the at least one label type by subtracting the number of labels of the at least one label type dispensed from the inventory count of the at least one label type;
adjusting the inventory count of the at least one label type in response to receiving an inventory adjustment number from the user; and
generating an action if the inventory count of one of the at least one label type falls below a predetermined level.

20. The method of claim 19 further comprising the steps of:
detecting a position of an article; and
commanding the labeler to dispense a label in response to the article being at a predetermined position.

21. The method of claim 20 wherein the step of commanding the labeler to dispense a label in response to the article being at a predetermined position comprises the step of commanding the labeler to dispense a label in response to the article being at a predetermined position and at a percentage hit rate.

22. The method of claim 19 further comprising the step of commanding the labeler to dispense labels in accordance with a hit rate percentage received from a user.

23. The method of claim 19 further comprising the step of generating an inventory report in response to receiving a request from at least one of a remote location and an operator interface.

24. The method of claim 19 wherein the labels are on at least one spool, the method further comprising the step of generating a second action if a number of the labels on one of the at least one spool falls below a predetermined threshold.

25. The method of claim 19 further comprising the step of setting the predetermined level to a new value in response to receiving a command from one of an operator interface and a remote location.

26. The method of claim 25 wherein the command is sent by a user and wherein the step of setting the predetermined level to a new value includes verifying the user is authorized to command the predetermined level to be set to the a new value.

27. The method of claim 19 wherein the at least one label type comprises a plurality of label types.

28. A label monitoring system comprising:
a labeler;
a controller operatively connected to the labeler, the controller comprising:
a label database having an inventory count of at least one label type;
a processing unit that updates the inventory count of the at least one label type being dispensed;
an operator interface operatively connected to the processing unit;
a position sensor for detecting a position of an article; and
a label driver for commanding the labeler to dispense a label in response to the article being at a predetermined position.

29. The label monitoring system of claim 28 further comprising a label sensor operatively connected to the labeler and wherein the processing unit updates the inventory count in response to the label sensor detecting the at least one label type.

30. The label monitoring system of claim 29 wherein the controller further comprises a counter for counting the number of labels dispensed.

31. The label monitoring system of claim 28 wherein the at least one label type comprises a plurality of label types.
